(19) United States
(12) Patent Application Publication
(10) Pub. No.: US 2025/0042036 A1
(43) Pub. Date: Feb. 6, 2025

(54) ROBOT DEVICE PROVIDED WITH THREE-DIMENSIONAL SENSOR AND METHOD FOR CONTROLLING ROBOT DEVICE

(71) Applicant: FANUC CORPORATION, Yamanashi (JP)

(72) Inventor: Junichirou YOSHIDA, Yamanashi (JP)

(21) Appl. No.: 18/715,735

(22) PCT Filed: Jan. 14, 2022
(86) PCT No.: PCT/JP2022/001188

§ 371 Date: Jun. 3, 2024

(51) Int. Cl. B25J 9/16; B25J 13/08

(52) U.S. Cl. CPC B25J 9/1697; B25J 9/1653; B25J 9/1664; B25J 13/089

(57) ABSTRACT

This robot device comprises: a positional information generation unit that generates three-dimensional positional information of a surface of a workpiece on the basis of an output from a visual sensor; and a face inference unit that infers face information related to a face including the surface of the workpiece on the basis of the three-dimensional positional information. The robot moves the visual sensor from a first position to a second position. A correction amount setting unit sets a correction amount for driving the robot in the second position so that a first face including the surface of the workpiece detected in the first position matches a second face including the surface of the workpiece detected in the second position.

### RELATED APPLICATIONS

The present application is a National Phase of International Application No. PCT/JP2022/001188 filed Jan. 14, 2022.

### TECHNICAL FIELD

The present invention relates to a robot device including a three-dimensional sensor and a control method of the robot device.

### BACKGROUND ART

A robot device including a robot and a work tool can perform various types of work by changing a position and orientation of the robot. It is known that a three-dimensional sensor detects a position of a workpiece in order for the robot to perform work at a position and orientation corresponding to the position and an orientation of the workpiece (e.g., Japanese Unexamined Patent Publication No. 2004-144557 A). The robot is driven based on the position and orientation of the workpiece detected by the three-dimensional sensor, and thus the robot device can accurately perform the work.

By using the three-dimensional sensor, it is possible to set a plurality of three-dimensional points at a surface of the workpiece included in a measurement region and detect a position of each of the three-dimensional points. It is also possible to generate a distance image or the like having different depths in response to distances based on the positions of the plurality of three-dimensional points.

When the workpiece is larger than the measurement region of the three-dimensional sensor, the robot device can perform measurement at a plurality of positions while movement the three-dimensional sensor. Three-dimensional point clouds acquired by arranging the three-dimensional sensor at the plurality of positions can be synthesized. For example, a three-dimensional camera is fixed to a hand of the robot device. The robot can perform imaging at the plurality of positions by changing the position and orientation thereof. Then, one large three-dimensional point cloud can be generated by synthesizing the three-dimensional point clouds measured at the respective positions.

Alternatively, when the surface of the workpiece is glossy, there is a case in which a position of a part of the workpiece cannot be measured due to halation of light (e.g., Japanese Unexamined Patent Publication No. 2019-113895A). When such halation occurs, imaging is performed at a plurality of positions while the position of the three-dimensional sensor is changed, and thus it is possible to compensate for three-dimensional points of the part at which the position cannot be measured.

### CITATION LIST

### Patent Literature

PTL 1: Japanese Unexamined Patent Publication No. 2004-144557A
PTL 2: Japanese Unexamined Patent Publication No. 2019-113895A

### SUMMARY OF INVENTION

### Technical Problem

When calculating the positions of the three-dimensional points set on the surface of the workpiece, a controller of the robot device converts positions in a sensor coordinate system set for the three-dimensional sensor into positions in a robot coordinate system. At this time, the positions of the three-dimensional points are converted based on the position and orientation of the robot. However, when there is an error in the position and orientation of the robot, this error may affect accuracy of the positions of the three-dimensional points. For example, there is a problem in that an error in the position and orientation of the robot due to backlash of a reduction gear causes an error in the positions of the three-dimensional points in the robot coordinate system. In particular, when the three-dimensional points are measured from a plurality of positions and three-dimensional point clouds are synthesized, there is a problem in that when the robot device is controlled based on the synthesized three-dimensional point clouds, the control becomes inaccurate.

### Solution to Problem

A robot device according to an aspect of the present disclosure includes a three-dimensional sensor for detecting a position of a surface of a workpiece and a robot changing a relative position between the workpiece and the three-dimensional sensor. The robot device includes a position information generating unit generating three-dimensional position information regarding the surface of the workpiece based on an output of the three-dimensional sensor and a face estimating unit estimating face information related to a face including the surface of the workpiece based on the three-dimensional position information. The robot device includes a correction amount setting unit setting a correction amount for driving the robot. The robot is configured to change the relative position between the workpiece and the three-dimensional sensor from a first relative position to a second relative position different from the first relative position. The correction amount setting unit sets the correction amount for driving the robot at the second relative position based on the face information so that a first face and a second face match each other, the first face being detected at the first relative position and including the surface of the workpiece, the second face being detected at the second relative position and including the surface of the workpiece.

A control method of a robot device according to an aspect of the present disclosure includes: arranging, by a robot, a relative position between a workpiece and a three-dimensional sensor at a first relative position; and generating, by a position information generating unit, three-dimensional position information regarding a surface of the workpiece at the first relative position based on an output of the three-dimensional sensor. The control method includes: arranging, by the robot, the relative position between the workpiece and the three-dimensional sensor at a second relative position different from the first relative position; and creating, by the position information generating unit, three-dimensional position information regarding the surface of the workpiece at the second relative position based on an output of the three-dimensional sensor. The control method includes estimating, by a face estimating unit, face information related to a face including the surface of the workpiece based on the three-dimensional position information at each of the relative positions. The control method includes setting, by a correction amount setting unit, a correction amount for driving the robot at the second relative position based on the face information so that a first face and a second face match each other, the first face being detected at the first relative position and including the surface of the workpiece, the second face being detected at the second relative position and including the surface of the workpiece.

### Advantageous Effects of Invention

According to a robot device and a control method of the robot device according to an aspect of the present disclosure, it is possible to set a correction amount of a robot that reduces an error of three-dimensional position information acquired from an output of a three-dimensional sensor.

### BRIEF DESCRIPTION OF DRAWINGS

FIG. 1 is a perspective view of a workpiece and a first robot device according to an embodiment.

FIG. 2 is a block diagram of the first robot device in the embodiment.

FIG. 3 is a schematic diagram of a vision sensor in the embodiment.

FIG. 4 is a perspective view of the vision sensor and the workpiece for describing a three-dimensional point cloud and a distance image.

FIG. 5 is a perspective view for describing a three-dimensional point cloud set at a surface of the workpiece.

FIG. 6 illustrates an example of a distance image generated based on an output of the vision sensor.

FIG. 7 is a perspective view of the workpiece and the first robot device when the vision sensor is moved to a second position.

FIG. 8 is a schematic cross-sectional view in a case in which there is no error in the second position when the vision sensor is moved to the second position.

FIG. 9 is a schematic cross-sectional view in a case in which there is an error in the second position when the vision sensor is moved to the second position.

FIG. 10 is a schematic cross-sectional view for describing a position of a three-dimensional point cloud in a robot coordinate system when there is an error in the second position of the vision sensor.

FIG. 11 is a schematic cross-sectional view of the vision sensor and the workpiece for describing a correction amount of a position of the vision sensor.

FIG. 12 is a flowchart of control performed at a time of teaching work of a robot device according to the embodiment.

FIG. 13 is a flowchart of control of work for conveying the workpiece according to the embodiment.

FIG. 14 is a perspective view of a second workpiece and the vision sensor according to the embodiment.

FIG. 15 is a block diagram of a face estimating unit in a modified example of the first robot device.

FIG. 16 is a perspective view of a third workpiece and the vision sensor according to the embodiment.

FIG. 17 is a schematic cross-sectional view of a fourth workpiece and the vision sensor according to the embodiment.

FIG. 18 is a schematic view of a second robot device according to the embodiment.

### DESCRIPTION OF EMBODIMENTS

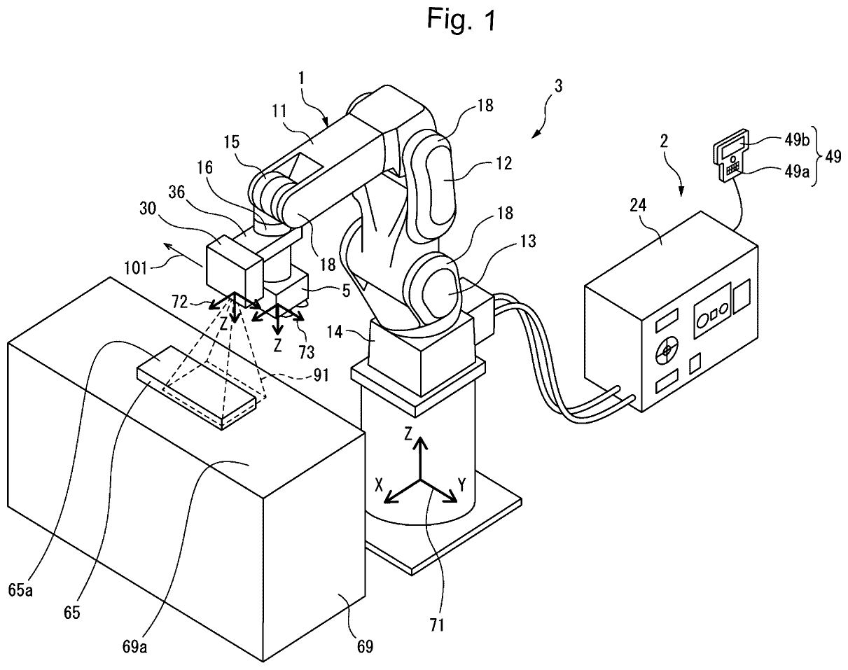

A robot device and a control method of the robot device according to an embodiment will be described with reference to FIG. 1 to FIG. 18. The robot device according to the present embodiment includes a three-dimensional sensor for detecting a position of a surface of a workpiece as an object on which work is to be performed. Three-dimensional position information such as a position of a three-dimensional point is acquired by processing an output of the three-dimensional sensor. First, a first robot device including a robot that changes a position and orientation of the three-dimensional sensor will be described.

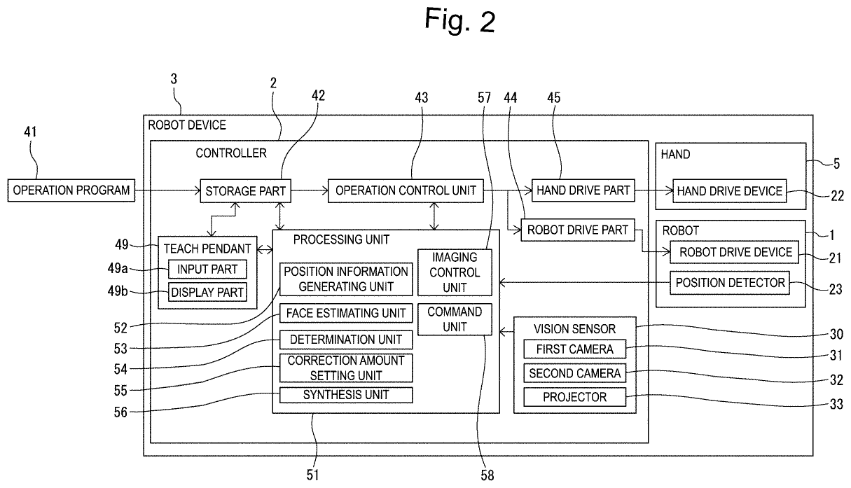

FIG. 1 is a perspective view of a first robot device according to the present embodiment. FIG. 2 is a block diagram of the first robot device according to the present embodiment. Referring to FIG. 1 and FIG. 2, a first robot device 3 conveys a workpiece 65. The first robot device 3 includes a hand 5 as a work tool for grasping the first workpiece 65 and a robot 1 as a movement mechanism that moves the hand 5. The robot device 3 includes a controller 2 that controls the robot 1 and the hand 5. The robot device 3 includes a vision sensor 30 as a three-dimensional sensor that outputs a signal for detecting a position of a surface of the workpiece 65.

The first workpiece 65 is a plate-like member including a surface 65a having a planar shape. The workpiece 65 is arranged at a surface 69a of a platform 69 as a placement member. In the first robot device 3, a position and orientation of the workpiece 65 are fixed. The hand 5 according to the present embodiment grasps the workpiece 65 by suction. The work tool is not limited to this configuration, and any work tool corresponding to work performed by the robot device 3 can be employed. For example, a working tool that performs welding or a working tool that applies a sealing material can be employed.

The robot 1 is a vertical articulated robot including a plurality of joints 18. The robot 1 includes an upper arm 11 and a lower arm 12. The lower arm 12 is supported by the turning base 13. The turning base 13 is supported by a base 14. The base 14 is fixed to an installation surface. The robot 1 includes a wrist 15 connected to an end portion of the upper arm 11. The wrist 15 includes a flange 16 for fixing the hand 5. The robot 1 according to the present embodiment includes six drive axes, but is not limited to this configuration. Any robot that can move the working tool can be employed.

The vision sensor 30 is attached to the flange 16 via a support member 36. In the first robot device 3, the vision sensor 30 is supported by the robot 1 such that the position and orientation thereof are changed together with the hand 5.

The robot 1 according to the present embodiment includes a robot drive device 21 that drives constituent members of the robot 1, such as the upper arm 11. The robot drive device 21 includes a plurality of drive motors for driving the upper arm 11, the lower arm 12, the turning base 13, and the wrist 15. The hand 5 includes a hand drive device 22 that drives the hand 5. The hand drive device 22 of the present embodiment drives the hand 5 by air pressure. The hand drive device 22 includes an air pump, a solenoid valve, and the like for supplying decompressed air to the hand 5.

The controller 2 includes an arithmetic processing device 24 (a computer) that includes a Central Processing Unit (CPU) as a processor. The arithmetic processing device 24 includes a Random Access Memory (RAM), a Read Only Memory (ROM), and the like which are connected to the CPU via a bus. In the robot device 3, the robot 1 and the hand 5 are driven in accordance with an operation program 41. The robot device 3 has a function of automatically conveying the workpiece 65.

The arithmetic processing device 24 of the controller 2 includes a storage part 42 that stores information regarding control of the robot device 3. The storage part 42 may be composed of a non-transitory storage medium capable of storing information. For example, the storage part 42 may be composed of a storage medium such as a volatile memory, a nonvolatile memory, a magnetic storage medium, or an optical storage medium. The operation program 41 prepared in advance for performing an operation of the robot 1 is stored in the storage part 42.

The arithmetic processing device 24 includes an operation control unit 43 that sends an operation command. The operation control unit 43 transmits an operation command for driving the robot 1 to a robot drive part 44 based on the operation program 41. The robot drive part 44 includes an electric circuit that drives the drive motors. The robot drive part 44 supplies electricity to the robot drive device 21 in accordance with the operation command. The operation control unit 43 sends an operation command for driving the hand drive device 22 to the hand drive part 45. The hand drive part 45 includes an electric circuit that drives a pump and the like. The hand drive part 45 supplies electricity to the hand drive device 22 based on the operation command.

The operation control unit 43 is equivalent to a processor that is driven in accordance with the operation program 41. The processor functions as the operation control unit 43 by reading the operation program 41 and performing control defined in the operation program 41.

The robot 1 includes a state detector for detecting the position and orientation of the robot 1. The state detector according to the present embodiment includes a position detector 23 attached to the drive motor of each drive axis of the robot drive device 21. The position detector 23 is composed of, for example, an encoder. The position and orientation of the robot 1 are detected from the output of the position detector 23.

The control device 2 includes a teach pendant 49 as an operation panel on which an operator manually operates the robot device 3. The teach pendant 49 includes an input part 49a for inputting information regarding the robot device 3. The input part 49a includes an operation member such as a keyboard and a dial. The teach pendant 49 includes the display part 49b that displays information regarding control of the robot device 3. The display part 49b is made of a display panel such as a liquid crystal display panel.

A robot coordinate system 71 that does not move even when the position and orientation of the robot 1 are changed is set for the robot device 3 according to the present embodiment. In the example illustrated in FIG. 1, an origin of the robot coordinate system 71 is arranged at the base 14 of the robot 1. The robot coordinate system 71 is also referred to as a world coordinate system. In the robot coordinate system 71, a position of the origin is fixed and orientations of coordinate axes are also fixed. The robot coordinate system 71 of the present embodiment is set such that the z-axis is parallel to the vertical direction.

A tool coordinate system 73 having an origin set at a given position of the work tool is set for the robot device 3. The position and orientation of the tool coordinate system 73 are changed together with the hand 5. In the present embodiment, the origin of the tool coordinate system 73 is set at a tool distal end point. The position of the robot 1 corresponds to the position of the tool distal end point (the position of the origin of the tool coordinate system 73). Moreover, the orientation of the robot 1 corresponds to the orientation of the tool coordinate system 73 with respect to the robot coordinate system 71.

Further, in the robot device 3, a sensor coordinate system 72 is set for the vision sensor 30. The sensor coordinate system 72 is a coordinate system having an origin fixed to an arbitrary position such as a lens center point of the vision sensor 30. The position and orientation of the sensor coordinate system 72 are changed together with the vision sensor 30. The sensor coordinate system 72 according to the present embodiment is set such that the Z-axis is parallel to an optical axis of a camera included in the vision sensor 30.

A relative position and orientation of the sensor coordinate system 72 with respect to a flange coordinate system set at a surface of the flange 16 or the tool coordinate system 73 are determined in advance. The sensor coordinate system 72 is calibrated so that the coordinate values of the robot coordinate system 71 can be calculated from the coordinate values of the sensor coordinate system 72 based on the position and orientation of the robot 1.

In each coordinate system, an X-axis, a Y-axis, and a Z-axis are defined. A W-axis around the X-axis, a P-axis around the Y-axis, and an R-axis around the Z-axis are also defined.

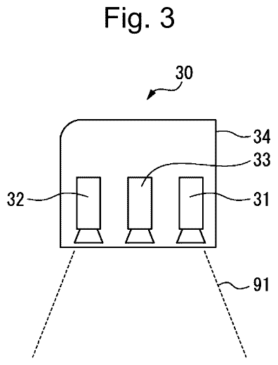

FIG. 3 is a schematic view of the vision sensor of the present embodiment. The vision sensor according to the present embodiment is a three-dimensional camera that can acquire three-dimensional position information regarding a surface of an object. Referring to FIG. 2 and FIG. 3, the vision sensor 30 of the present embodiment is a stereo camera including a first camera 31 and a second camera 32. Each of the cameras 31 and 32 is a two-dimensional camera that can obtain a two-dimensional image by imaging. The vision sensor 30 of the present embodiment includes a projector 33 that projects a pattern light such as a stripe pattern toward the workpiece 65. The cameras 31 and 32 and the projector 33 are arranged inside a housing 34.

Referring to FIG. 2, the controller 2 of the robot device 3 includes the vision sensor 30. The robot 1 changes the relative position between the workpiece 65 and the vision sensor 30. The controller 2 includes a processing unit 51 that processes an output of the vision sensor 30. The processing unit 51 includes a position information generating unit 52 that generates three-dimensional position information regarding the surface of the workpiece 65 based on the output from the vision sensor 30. The processing unit 51 includes a face estimating unit 53 that estimates face information related to a face including the surface of the workpiece based on the three-dimensional position information. The face information is information for specifying the surface of the workpiece. For example, when the surface of the workpiece is planar, the face information includes an equation of the surface in the robot coordinate system.

The processing unit 51 includes a correction amount setting unit 55 that sets a correction amount for driving the robot 1. The robot 1 changes the relative position between the workpiece 65 and the vision sensor 30 from a first relative position to a second relative position different from the first relative position. The processing unit 51 includes a determination unit 54 that determines whether or not a first face that is detected at the first relative position and that includes the surface of the workpiece 65 and a second face that is detected at the second relative position and that includes the surface of the workpiece 65 match within a predetermined determination range. The correction amount setting unit 55 sets the correction amount for driving the robot at the second relative position based on the face information so that the first face and the second face match each other. For example, the correction amount setting unit 55 sets the correction amount for driving the robot at the second relative position based on the face information so that the first face and the second face match each other within a predetermined range.

The processing unit 51 includes a synthesis unit 56 that synthesizes a plurality of pieces of three-dimensional position information regarding the surface of the workpiece acquired at a plurality of relative positions. In this example, the synthesis unit 56 synthesizes the three-dimensional position information detected at the first relative position and the three-dimensional position information detected at the second relative position. In particular, the synthesis unit 56 uses the three-dimensional position information generated at the second relative position corrected based on the correction amount set by the correction amount setting unit 55.

The processing unit 51 includes an imaging control unit 57 that controls imaging of the vision sensor 30. The processing unit 51 includes a command unit 58 that transmits a command for an operation of the robot 1. The command unit 58 according to the present embodiment transmits a command for correcting the position and orientation of the robot 1 to the operation control unit 43 based on the correction amount of the operation of the robot 1 set by the correction amount setting unit 55.

The processing unit 51 described above is equivalent to a processor that is driven in accordance with the operation program 41. The processor performs the control defined in the operation program 41, thereby functioning as the processing unit 51. In addition, the position information generating unit 52, the face estimating unit 53, the determination unit 54, the correction amount setting unit 55, and the synthesis unit 56 included in the processing unit 51 correspond to a processor driven in accordance with the operation program 41. The imaging control unit 57 and the command unit 58 also correspond to the processor driven in accordance with the operation program 41. The processor functions as each of the units by performing control determined by the operation program 41.

The position information generating unit 52 of the present embodiment calculates a distance from the vision sensor 30 to a three-dimensional point set on a surface of an object based on parallax between an image captured by the first camera 31 and an image captured by the second camera 32. The three-dimensional point can be set for each pixel of an image sensor, for example. The position information generating unit 52 calculates a distance from the vision sensor 30 to each three-dimensional point. The position information generating unit 52 further calculates the coordinate values of the position of the three-dimensional point in the sensor coordinate system 72 based on the distance from the vision sensor 30.

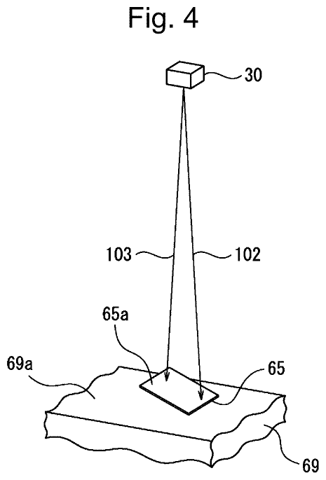

FIG. 4 is a perspective view of the vision sensor and the workpiece for describing an example of a three-dimensional point cloud and a distance image. In this example, the workpiece 65 is arranged in a tilted manner at the surface 69a of the platform 69. The surface 69a of the platform 69 extends perpendicular to the optical axes of the cameras 31 and 32 of the vision sensor 30. Images captured by the cameras 31 and 32 of the vision sensor 30 are processed, and thus, as indicated by arrows 102 and 103, the distance from the vision sensor 30 to the three-dimensional point set on the surface of a workpiece 63 can be detected.

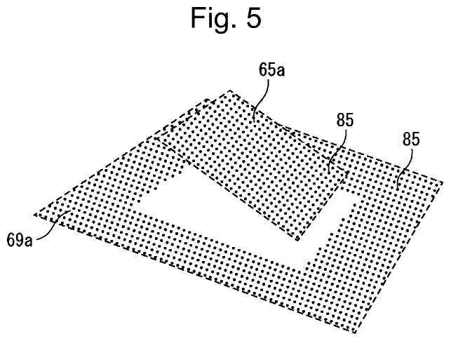

FIG. 5 is a perspective view of a three-dimensional point cloud generated by the position information generating unit. In FIG. 5, the contour of the workpiece 65 and the contour of a measurement region 91 are indicated by broken lines. A three-dimensional point 85 is located on a surface of an object facing the vision sensor 30. The position information generating unit 52 sets the three-dimensional point 85 on the surface of the object included in the measurement region 91. In this case, a large number of three-dimensional points 85 are arranged on the surface 65a of the workpiece 65. Also, a large number of three-dimensional points 85 are arranged on the surface 69a of the platform 69 inside the measurement region 91.

In this manner, the position information generating unit 52 can present the surface of the workpiece 65 as the three-dimensional point cloud. The position information generating unit 52 can generate the three-dimensional position information regarding the surface of the object in a form of a distance image or position information regarding the three-dimensional points (three-dimensional map). The distance image represents the position information regarding the surface of the object by a two-dimensional image. The distance image indicates distances from the vision sensor 30 to the three-dimensional points by depths or colors of respective pixels. On the other hand, the three-dimensional map represents the position information regarding the surface of the object by a set of coordinate values (x, y, z) of the three-dimensional points on the surface of the object. Such coordinate values can be represented in the robot coordinate system 71 or the sensor coordinate system 72.

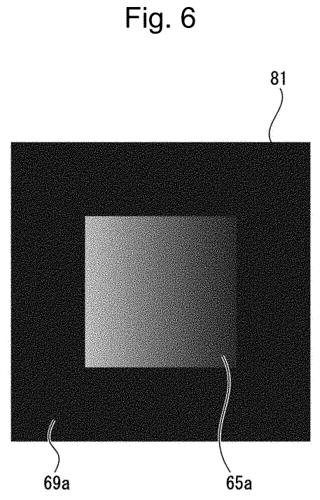

FIG. 6 illustrates an example of a distance image obtained based on an output of the vision sensor. The position information generating unit 52 can generate a distance image 81 in which the depths of colors change in response to distances from the vision sensor 30 to the three-dimensional points 85. In this example, the distance image 81 is generated such that the farther the distance from the vision sensor 30 is, the deeper the color is. The color of the surface 65a of the workpiece 65 is lighter as the surface 65a is closer to the vision sensor 30. Although the present embodiment will be described using the positions of the three-dimensional points as the three-dimensional position information regarding the surface of the object, similar control can be performed using the distance image.

The position information generating unit 52 of the present embodiment is disposed at the processing unit 51 of the arithmetic processing device 24, but is not limited to this configuration. The position information generating unit may be arranged inside the three-dimensional sensor. In other words, the three-dimensional sensor may include an arithmetic processing device including a processor such as a CPU, and the processor of the arithmetic processing device of the three-dimensional sensor may function as the position information generating unit. In that case, the three-dimensional position information such as the three-dimensional map or the distance image is output from the vision sensor.

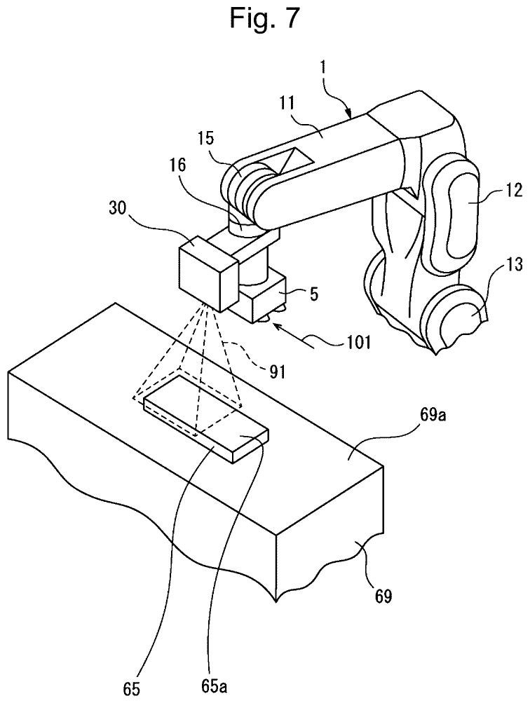

FIG. 7 is a perspective view of the robot device and the workpiece when the first robot device moves the vision sensor to the second position. Referring to FIG. 1 and FIG. 7, the robot device 3 grasps the surface 65a of the workpiece 65 with the hand 5. The robot device 3 performs control of conveying the workpiece 65 from the surface 69a of the platform 69 to a predetermined given position. For example, the robot device 3 performs control of conveying the workpiece 65 to a nearby conveyor, shelf, or the like.

In the present embodiment, when the robot 1 is at a predetermined position and orientation, the workpiece 65 having the surface 65a larger in area than the measurement region 91 of the vision sensor 30 is measured. In other words, the workpiece 65 has such a large size that the entire surface 65a cannot be imaged by performing imaging one time. The surface 65a is larger than the measurement region 91 and includes a part that lies out of the measurement region 91.

Alternatively, the length of the surface 65a in one given direction is larger than the length of the measurement region 91 in the one given direction. For this reason, in the present embodiment, imaging is performed a plurality of times while the position (viewpoint) of the vision sensor 30 is changed. The robot device 3 changes the relative position between the workpiece 65 and the vision sensor from the first relative position to the second relative position different from the first relative position. The three-dimensional position information regarding the entire surface 65a of the workpiece 65 is generated by performing imaging at the respective positions. In this case, three-dimensional points are set on the entire surface 65a of the workpiece 65. Then, the position and orientation of the robot 1 when the robot 1 grasps the workpiece 65 with the hand 5 are calculated based on the three-dimensional position information.

In FIG. 1, the vision sensor 30 is arranged at a first position and orientation (first viewpoint). The position information generating unit 52 sets three-dimensional points on the surface 65a arranged inside the measurement region 91. The position information generating unit 52 sets three-dimensional points at one end portion of the surface 65a. Next, the robot 1 changes the position and orientation of the vision sensor 30 so as to move the vision sensor 30 as indicated by an arrow 101. In this case, the vision sensor 30 is parallel translated in the horizontal direction. In FIG. 7, the vision sensor 30 is arranged at a second position and orientation (second viewpoint). The position information generating unit 52 sets three-dimensional points at the other end portion of the surface 65a.

The measurement region 91 of the vision sensor 30 at the first position illustrated in FIG. 1 and the measurement region 91 of the vision sensor 30 at the second position illustrated in FIG. 7 partially overlap. The synthesis unit 56 synthesizes the three-dimensional point cloud acquired at the first position and the three-dimensional point cloud acquired at the second position, thereby setting the three-dimensional points on the entire surface 65a. In this example, the vision sensor 30 performs imaging two times and thus the three-dimensional points can be set on the entire surface 65a.

Then, the command unit 58 can calculate the position and orientation of the surface 65a of the workpiece 65 based on the three-dimensional point cloud set on the surface 65a. The command unit 58 can calculate the position and orientation of the robot 1 for grasping the workpiece 65 based on the position and orientation of the workpiece 65.

The first position and orientation of the vision sensor 30 and the second position and orientation of the vision sensor 30 for measuring the surface of the workpiece 65 can be set by given control. For example, the operator can display an image captured by one of the two-dimensional cameras of the vision sensor 30 on the display part 49b of the teach pendant 49. Then, the position and orientation of the robot 1 can be adjusted by operating the input part 49a while viewing the image displayed on the display part 49b.

As illustrated in FIG. 1, the operator can adjust the position and orientation of the robot so that one side of the workpiece 65 is arranged inside the measurement region 91. Further, as illustrated in FIG. 7, the position and orientation of the robot can be manually adjusted so that the other side of the workpiece 65 is arranged inside the measurement region 91. The operator can store, in the storage part 42, the position and orientation of the robot when the vision sensor 30 is arranged at a desired position and orientation. Alternatively, the position and orientation of the vision sensor may be set in advance by a simulation device or the like.

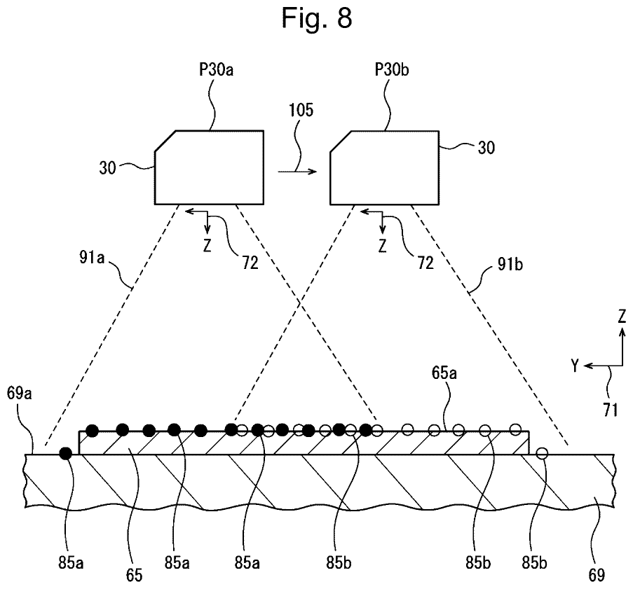

FIG. 8 is a schematic cross-sectional view of the vision sensor and the workpiece when the robot is driven ideally. The surface 69a of the platform 69 according to the present embodiment is planar and extends horizontally. Alternatively, the surface 65a of the workpiece 65 is planar and extends horizontally. The vision sensor 30 moves from a first position P30a to a second position P30b as indicated by an arrow 105. In this example, the position of the vision sensor 30 is changed while the orientation is not changed. The vision sensor 30 is moved in the horizontal direction parallel to the Y-axis of the robot coordinate system 71.

FIG. 8 illustrates a case in which there is no error in the actual position and orientation of the robot 1 in response to a command value of the robot 1. Three-dimensional points 85a and 85b indicate positions of coordinate values in the sensor coordinate system 72. Moreover, when there is no error in the actual position and orientation of the robot, the three-dimensional points 85a and 85b are arranged at the same positions even when the coordinate values in the sensor coordinate system 72 are converted into the coordinate values in the robot coordinate system 71.

Based on an output of the vision sensor 30 arranged at the first position P30a, the three-dimensional points 85a are set on the surface 65a of the workpiece 65 and the surface 69a of the platform 69. In addition, based on an output of the vision sensor 30 arranged at the second position P30b, the three-dimensional points 85b are set on the surface 65a and the surface 69a. A part of a measurement region 91a at the first position P30a and a part of a measurement region 91b at the second position P30b overlap each other. In the overlapping region, the three-dimensional points 85a and the three-dimensional points 85b are arranged. However, since there is no error in the position and orientation of the robot, the three-dimensional points 85a and 85b set on the surface 65a are on the same plane. Thus, the processing unit 51 can accurately estimate the position and orientation of the workpiece 65 by synthesizing the point cloud of the three-dimensional points 85a and the point cloud of the three-dimensional points 85b.

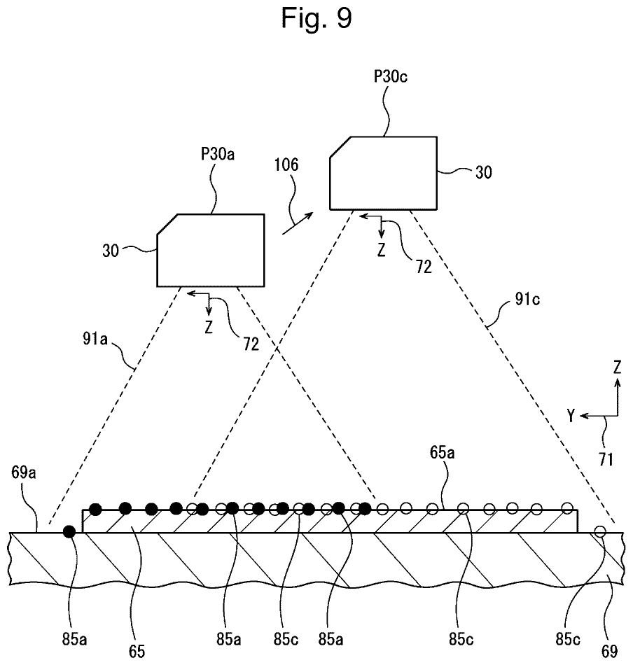

FIG. 9 is a schematic cross-sectional view of the vision sensor and the workpiece when there is an error in the position and orientation of the robot when the vision sensor is moved to the second position. When the robot is driven, there may be an error in the actual position and orientation in response to a command value determined in the operation program. For example, due to a movement error caused by a driving mechanism such as backlash of a transmission, the actual position and orientation of the robot may be displaced with respect to the command value. In this case, the movement error of the robot corresponds to positional errors of three-dimensional points.

In the example illustrated in FIG. 9, the command value is generated so that the vision sensor 30 is moved in the horizontal direction as in FIG. 8. However, the vision sensor 30 is moved from the first position P30a to a second position P30c displaced upward as indicated by an arrow 106. The position information generating unit 52 detects three-dimensional points 85a and 85c in the sensor coordinate system 72. The Z-axis coordinate values of the three-dimensional points 85a in the sensor coordinate system 72 are different from the Z-axis coordinate values of the three-dimensional points 85c in the sensor coordinate system 72.

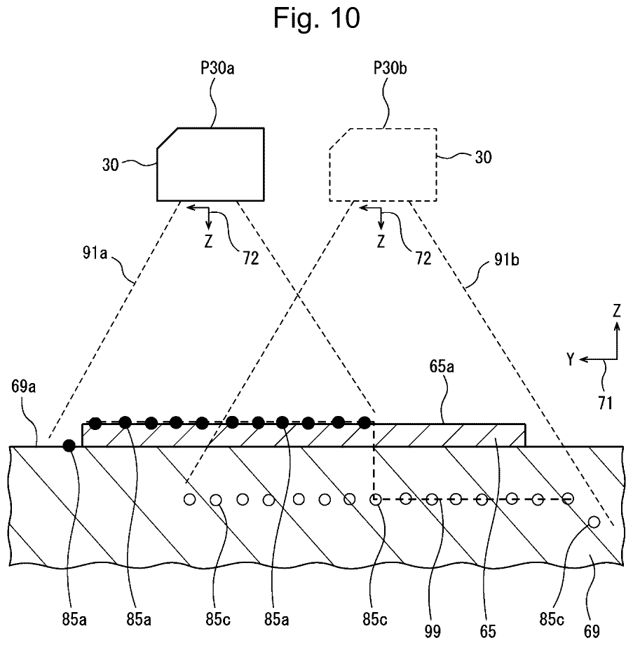

FIG. 10 illustrates the positions of the three-dimensional points represented by the coordinate values in the robot coordinate system when the three-dimensional points are detected at the second position including an error. The processing unit 51 converts the coordinate values in the sensor coordinate system 72 into the coordinate values in the robot coordinate system 71 on the assumption that the vision sensor 30 is arranged at the second position P30b. The coordinate values in the sensor coordinate system 72 are converted into the coordinate values in the robot coordinate system 71 using the coordinate values of the second position P30b in the robot coordinate system. Thus, the positions of the three-dimensional points 85c in the robot coordinate system 71 are calculated on the condition that the vision sensor 30 is arranged at the second position P30b.

The Z-axis coordinate values of the three-dimensional points 85c in the sensor coordinate system 72 increase, and the three-dimensional points 85c are arranged at positions displaced from the surface 65a of the workpiece 65. In this example, the positions of the three-dimensional points 85c below the surface 65a are calculated.

As to the three-dimensional points 85a and the three-dimensional points 85c in the region in which the measurement region 91a and the measurement region 91b overlap each other, for example, the three-dimensional points 85a closer to the vision sensor 30 can be adopted. In this case, it is determined that there is a step at the surface of the workpiece 65 as indicated by a face 99. As described above, an error in driving of the robot causes a problem in that the positions of the three-dimensional points at the entire surface 65a of the workpiece 65 cannot be accurately detected.

Thus, when the vision sensor 30 is arranged at the second position, the processing unit 51 according to the present embodiment sets a correction amount for driving the robot 1 so that the vision sensor 30 is arranged at the second position P30b corresponding to the command value of the position and orientation of the robot 1.

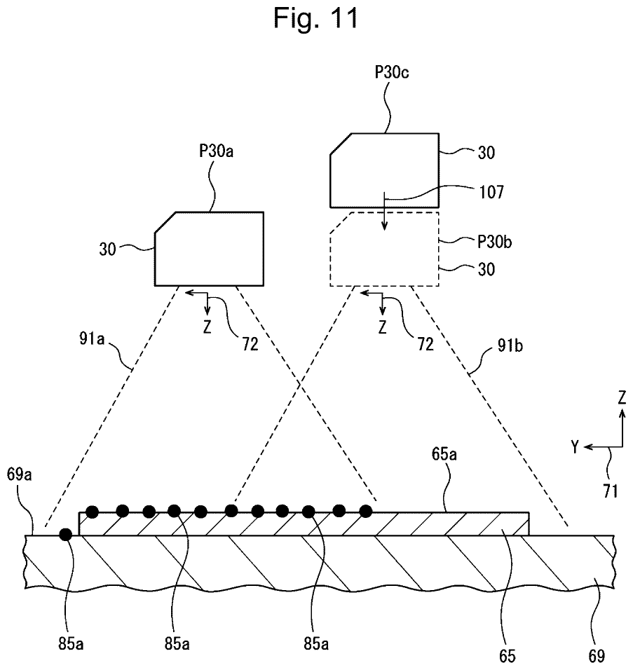

FIG. 11 is a schematic view of the vision sensor and the workpiece when a correction value is calculated and the robot is driven. The processing unit 51 according to the present embodiment sets a correction amount indicated by an arrow 107 so that the vision sensor 30 arranged at the second position P30c is to be arranged at the second position P30b. As the correction amount, a correction amount with respect to the command value of the position and orientation of the robot can be adopted. In particular, the correction amount setting unit 55 searches for the second position so that a plane defined by the first three-dimensional points 85a acquired at the first position and a plane defined by the second three-dimensional points 85c acquired at the second position are on the same plane when the vision sensor 30 is arranged at the second position. In other words, face matching control for matching the two faces is performed. The correction amount for driving the robot is set based on the corrected second position of the vision sensor 30.

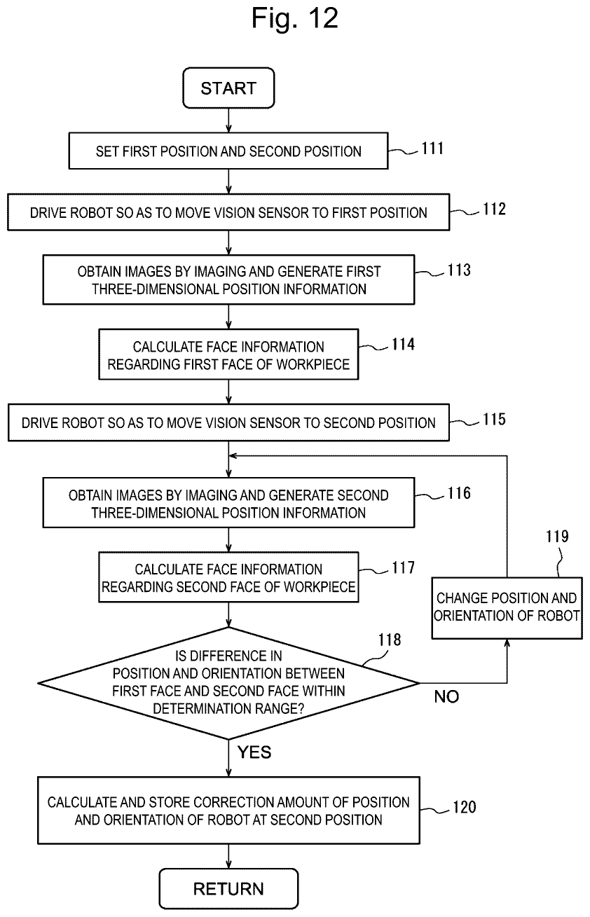

FIG. 12 is a flowchart of control of the first robot device according to the present embodiment. The control illustrated in FIG. 12 includes the face matching control of matching a first face with a second face. The first face is a face that is detected at the first relative position and that includes the surface of the workpiece 65, and serves as a reference face of the face matching control. The second face is a face that is detected at the second relative position and that includes the surface of the workpiece 65. The control illustrated in FIG. 12 can be performed in teaching work before actual work is performed.

Referring to FIG. 9 and FIG. 12, in step 111, the first position P30a and the second position P30c of the vision sensor 30 for imaging the workpiece are set. In the present embodiment, the operator sets the first position P30a and the second position P30c by operating the teach pendant 49. The storage part 42 stores a command value of the robot 1 at each position.

In this case, the position of the vision sensor is parallel translated so that the orientation of the vision sensor 30 at the first position P30a is the same as the orientation of the vision sensor 30 at the second position P30b. For example, the vision sensor is moved in the negative direction of the Y-axis of the robot coordinate system 71. However, the vision sensor 30 is also moved in the Z-axis direction due to an error or the like of the driving mechanism of the robot 1.

Next, in step 112, the command unit 58 drives the robot 1 so as to move the vision sensor 30 to the first position P30a. In this example, when the vision sensor 30 is arranged at the first position P30a, the robot 1 is driven without an error in the actual position and orientation of the robot 1 with respect to the command value of the robot 1.

In step S113, the imaging control unit 57 transmits, to the vision sensor 30, a command for obtaining images by imaging. The vision sensor 30 obtains images by imaging. The position information generating unit 52 generates first three-dimensional position information in the measurement region 91a based on an image of the first camera 31 and an image of the second camera 32. In this case, the first three-dimensional points 85a are set on the surface 65a of the workpiece 65 and the surface 69a of the platform 69. The position information generating unit 52 is calibrated so as to be able to convert the coordinate values in the sensor coordinate system 72 into the coordinate values in the robot coordinate system 71. The position information generating unit 52 calculates the positions of the three-dimensional points 85a in the sensor coordinate system 72. The position information generating unit 52 converts the coordinate values in the sensor coordinate system 72 into the coordinate values in the robot coordinate system 71. The positions of the first three-dimensional points 85a as the first three-dimensional position information are calculated based on the coordinate values of the robot coordinate system 71.

In step 114, the face estimating unit 53 calculates face information related to the first face including the surface 65a of the workpiece 65. The face estimating unit 53 calculates an equation of a plane including the three-dimensional points 85a in the robot coordinate system 71 as the face information regarding the first face. The face estimating unit 53 eliminates three-dimensional points having coordinate values significantly different from predetermined determination values among the acquired three-dimensional points 85a. In this case, the three-dimensional points 85a arranged on the surface 69a of the platform 69 are eliminated. Alternatively, a range in which the plane is estimated in the images may be determined in advance. For example, when manually setting the first position and orientation of the vision sensor 30, the operator may designate the range in which the plane is estimated in the images captured by the two-dimensional cameras while viewing the images. The face estimating unit 53 extracts the three-dimensional points 85a within the range in which the plane is estimated. Next, the face estimating unit 53 calculates the equation of the plane in the robot coordinate system 71 so as to follow the point cloud of the three-dimensional points 85a. For example, the plane equation of the first face in the robot coordinate system 71 is calculated by the least squares method so that an error with respect to the coordinate values of the three-dimensional points becomes small.

Next, in step 115, the command unit 58 moves the vision sensor 30 from the first position P30a to the second position P30c as indicated by the arrow 106. The vision sensor 30 is moved by driving the robot 1.

In step 116, the imaging control unit 57 transmits, to the vision sensor 30, a command for obtaining images by imaging. The vision sensor 30 obtains images by imaging. The position information generating unit 52 sets the second three-dimensional points 85c corresponding to the surface 65a of the workpiece 65. The position information generating unit 52 calculates the positions of the three-dimensional points 85c as second three-dimensional position information. The position information generating unit 52 calculates the positions of the second three-dimensional points 85c based on the coordinate values in the robot coordinate system 71.

Next, in step 117, the face estimating unit 53 calculates face information regarding the second face including the surface 65a of the workpiece 65. The face estimating unit 53 can eliminate the second three-dimensional points 85c arranged on the surface 69a of the platform 69. Alternatively, a range in which the plane is estimated in the images may be determined in advance. For example, when manually setting the second position and orientation of the vision sensor 30, the operator may designate the range in which the plane is estimated on the screen while viewing the images captured by the two-dimensional cameras. The face estimating unit 53 extracts the three-dimensional points 85c within the range in which the plane is estimated. Next, the face estimating unit 53 calculates the face information regarding the second face based on the positions of the plurality of second three-dimensional points 85c. The face estimating unit 53 calculates a plane equation of the second face including the three-dimensional points 85c in the robot coordinate system 71 by the least squares method.

Next, in step 118, the determination unit 54 determines whether or not the first face and the second face match each other within a predetermined determination range. Specifically, the determination unit 54 calculates whether or not the difference between the position and orientation of the first face and the position and orientation of the second face is within the determination range. In this example, the determination unit 54 calculates a normal vector from the origin of the robot coordinate system 71 toward the first face based on the equation of the first face of the first three-dimensional points 85a. Similarly, the determination unit 54 calculates a normal vector from the origin of the robot coordinate system 71 toward the second face based on the equation of the second face of the second three-dimensional points 85c.

The determination unit 54 compares the length of the normal vector and the direction of the normal vector of the first face with those of the second face. When the difference in the length of the normal vector is within a predetermined determination range and the difference in the direction of the normal vector is within a predetermined determination range, it can be determined that the difference in the position and orientation between the first face and the second face is within the determination range. The determination unit 54 determines that the degree of matching between the first face and the second face is high. In step 118, when the difference between the position and orientation of the first face and the position and orientation of the second face deviates from the determination range, the control proceeds to step 119. It should be noted that when the relative position between the vision sensor and the workpiece is changed, the relative orientation between the vision sensor and the workpiece may not be changed. For example, as illustrated in FIG. 9, there is a case in which it is known in advance that the orientation of the vision sensor hardly changes when the vision sensor is moved with respect to the workpiece. When there is no error in the relative orientation between the workpiece and the vision sensor, the relative orientation does not need to be evaluated based on the first face and the second face of the workpiece in step 118. For example, it is not necessary to evaluate the directions of the normal vectors.

In step 119, the command unit 58 transmits a command for changing the position and orientation of the robot 1. In this example, the command unit 58 changes the position and orientation of the robot 1 by a minute amount. The command unit 58 can perform control of slightly moving the position and orientation of the robot 1 in a predetermined direction. For example, the command unit 58 performs control of slightly moving the vision sensor 30 upward or downward in the vertical direction. Alternatively, the command unit 58 may perform control of driving the drive motor at each drive axis so as to rotate the constituent member by a predetermined angle in a predetermined direction. It should be noted that in a case in which the relative orientation between the vision sensor and the workpiece is not changed when the relative position between the vision sensor and the workpiece is changed, the orientation of the robot does not need to be changed in step 119.

After changing the position and orientation of the robot 1, the control returns to step 116. The processing unit 51 repeats the control from step 116 to step 118. In this manner, in the control of FIG. 12, the control of searching for the position of the vision sensor 30 at which the first face and the second face match each other is performed while the position of the vision sensor 30 is changed. In step 118, when the difference in the position and orientation between the first face and the second face is within the determination range, the control proceeds to step 120. In this case, referring to FIG. 11, it can be determined that the vision sensor 30 is moved from the second position P30c to the second position P30b.

Referring to FIG. 12, in step 120, the correction amount setting unit 55 sets a correction amount for moving the vision sensor 30 from the second position P30c to the second position P30b. The arrow 107 illustrated in FIG. 11 corresponds to the correction amount. The storage part 42 stores the correction amount for driving the robot so as to arrange the vision sensor 30 at the second position. The correction amount setting unit 55 according to the present embodiment sets the correction amount with respect to the command value of the position and orientation of the robot 1. The correction amount is not limited to this configuration and may be determined by the rotation angle of the drive motor of each drive axis. Moreover, when the relative orientation is not evaluated based on the first face and the second face in step 118, the correction amount with respect to the command value of the orientation of the robot does not need to be calculated.

In the above-described embodiment, when the difference between the position and orientation of the first face and the position and orientation of the second face is within the determination range, it is determined that the degree of matching between the first face and the second face is high, but the embodiment is not limited to this. After the position of the robot is changed a predetermined number of times, the position and orientation of the robot having the highest degree of matching of the faces may be adopted. The correction amount at the second position may be set based on the position and orientation of the robot 1 at this time.

Alternatively, referring to FIG. 9, the correction amount setting unit 55 may set the correction amount based on the coordinate values of the three-dimensional points 85a in the sensor coordinate system 72 at the first position P30a and the coordinate values of the three-dimensional points 85c in the sensor coordinate system 72 at the second position P30c. In this example, an equation of a first plane in the sensor coordinate system 72 is calculated based on the first three-dimensional points 85a, and an equation of a second plane in the sensor coordinate system 72 is calculated based on the second three-dimensional points 85c. Then, the correction amount may be calculated based on the difference in the position and the difference in the orientation between the first plane and the second plane. In this case, the correction amount in the Z-axis direction of the sensor coordinate system 72 is calculated. Then, the correction amount in the sensor coordinate system 72 can be converted into the correction amount in the robot coordinate system 71.

In the examples illustrated in FIG. 8 to FIG. 11, the second position is determined so that the orientation of the vision sensor 30 is maintained constant. In other words, the second position is determined so that the vision sensor 30 is parallel translated without change in the orientation of the vision sensor 30, but the embodiment is not limited to this. The robot 1 according to the present embodiment is an articulated robot. The robot 1 can change the relative orientation between the workpiece 65 and the vision sensor 30 from a first relative orientation to a second relative orientation. Thus, the position and orientation of the vision sensor may be changed from the first position and orientation to the second position and orientation. The processing unit can control the orientation of the vision sensor in a manner similar to the control of the position of the vision sensor. The correction amount setting unit can set the correction amount of the second position and the correction amount of the second orientation of the vision sensor. In other words, the correction amount setting unit may set the correction amount of the orientation in addition to the correction amount of the position.

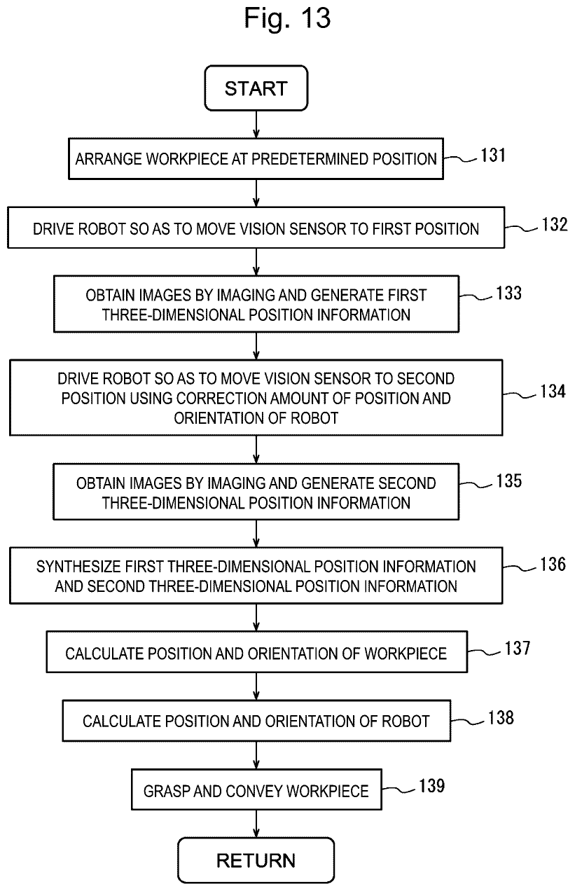

FIG. 13 is a flowchart of control when performing actual work of conveying the workpiece. In the actual work, the vision sensor is moved to the second position using the correction amount set by the correction amount setting unit 55. In step 131, the operator or another device arranges the workpiece 65 at a predetermined position of the surface 69a of the platform 69. The workpiece is arranged inside a measurement region obtained by adding a measurement region of the vision sensor 30 at the first position and a measurement region of the vision sensor 30 at the second position.

In step 132, the operation control unit 43 drives the robot 1 so as to move the vision sensor 30 to the first position. In step 133, the imaging control unit 57 obtains images by imaging with the vision sensor 30. The position information generating unit 52 generates first three-dimensional position information.

Next, in step 134, the operation control unit 43 drives the robot 1 so as to move the vision sensor 30 to the corrected second position using the correction amount of the position and orientation of the robot 1 set by the correction amount setting unit 55 in the teaching work. The operation control unit 43 arranges the vision sensor at a position obtained by reflecting the correction amount in the command value. In other words, the robot is driven using a command value obtained by correcting the command value (coordinate values) of the position and orientation based on the correction amount. Referring to FIG. 11, the correction amount is applied as indicated by the arrow 107, and the vision sensor 30 is arranged at the second position P30b. It should be noted that there is a case in which it is known in advance that no error occurs in the relative orientation between the workpiece and the vision sensor and the correction amount setting unit 55 calculates the correction amount of the position of the robot and does not calculate the correction amount of the orientation of the robot. In this case, the vision sensor 30 may be moved using only the correction amount of the position of the robot.

Next, in step 135, the imaging control unit 57 obtains images by imaging with the vision sensor 30. The position information generating unit 52 acquires the images from the vision sensor 30 and generates second three-dimensional position information. Since the position of the robot 1 at the second position is corrected, the three-dimensional points arranged on the surface 65a of the workpiece 65 can be accurately calculated in the robot coordinate system 71. In this regard, when the command value of the robot with respect to the second position is corrected, the position information generating unit 52 converts the positions (coordinate values) of the three-dimensional points represented in the sensor coordinate system 72 into the positions (coordinate values) of the three-dimensional points represented in the robot coordinate system 71 using the command value of the robot before correction.

Next, in step 136, the synthesis unit 56 synthesizes the first three-dimensional position information acquired at the first position and the second three-dimensional position information acquired at the second position. As the three-dimensional position information, the positions of the three-dimensional points are adopted. In the present embodiment, for a region in which the measurement region of the vision sensor at the first position and the measurement region of the vision sensor at the second position overlap, the positions of the three-dimensional points having shorter distances from the vision sensor 30 are adopted. Alternatively, in the overlapping range, average positions of the positions of the three-dimensional points acquired at the first position and the positions of the three-dimensional points acquired at the second position may be calculated. Alternatively, both three-dimensional points may be adopted.

Next, in step 137, the command unit 58 calculates the position and orientation of the workpiece 65. The command unit 58 eliminates three-dimensional points having coordinate values deviating from a predetermined range among the acquired three-dimensional points. In other words, the command unit 58 eliminates the three-dimensional points 85a arranged on the surface 69a of the platform 69. The command unit 58 estimates the contour of the surface 65a of the workpiece 65 based on the plurality of three-dimensional points. The command unit 58 calculates a grasping position of the surface 65a of the workpiece 65 where the hand 5 is to be arranged substantially at the center of the surface 65a. Further, the command unit 58 calculates the orientation of the workpiece at the grasping position.

In step 138, the command unit 58 calculates the position and orientation of the robot 1 so as to arrange the hand 5 at the grasping position for grasping the workpiece 65. In step 139, the command unit 58 transmits the position and orientation of the robot 1 to the operation control unit 43. The operation control unit 43 grasps the workpiece 65 with the hand 5 by driving the robot 1. Thereafter, the operation control unit 43 drives the robot 1 so as to convey the workpiece 65 to a predetermined position based on the operation program 41.

In this manner, the control method of the robot device according to the present embodiment includes a step of arranging, by the robot, the relative position between the workpiece and the vision sensor at the first relative position, and a step of generating, by the position information generating unit, the three-dimensional position information regarding the surface of the workpiece at the first relative position based on the output of the vision sensor. The control method includes a step of arranging, by the robot, the relative position between the workpiece and the vision sensor at the second relative position different from the first relative position, and a step of creating, by the position information generating unit, the three-dimensional position information of the workpiece at the second relative position based on the output of the vision sensor. Then, the control method includes a step of estimating, by the face estimating unit, the face information related to the face including the surface of the workpiece based on the three-dimensional position information. The control method includes a step of setting, by the correction amount setting unit, the correction amount for driving the robot at the second relative position based on the face information. The correction amount setting unit sets the correction amount so that the first face and the second face match each other, the first face being detected at the first relative position and including the surface of the workpiece, the second face being detected at the second relative position and including the surface of the workpiece.

In the present embodiment, when the vision sensor performs measurement of one workpiece a plurality of times, the correction amount for driving the robot is set so that faces generated from respective pieces of three-dimensional position information match each other. Thus, it is possible to set the correction amount of the robot that reduces an error of the three-dimensional position information acquired from the output of the three-dimensional sensor. In the actual work, the position and orientation of the robot are corrected based on the set correction amount, and thus the three-dimensional points can be accurately set on the surface of the workpiece even when measurement is performed a plurality of times. It is possible to accurately detect the surface of the workpiece and accurately perform work of the robot device. For example, in the present embodiment, it is possible to accurately detect the position and orientation of the workpiece and to suppress the robot device failing to grasp the workpiece or unstably grasping the workpiece. Alternatively, even in a case in which the three-dimensional points are complemented when halation occurs, the three-dimensional points can be accurately set.

It should be noted that the position and orientation of the robot when the vision sensor is arranged at the first position may be adjusted in advance so as to strictly match the command value of the position and orientation in the robot coordinate system. In the above-described embodiment, the robot 1 moves the vision sensor 30 to the two positions, and thus the workpiece 65 and the vision sensor 30 are arranged at the two relative positions, but the embodiment is not limited to this. The robot may change the relative position between the workpiece and the vision sensor to three or more mutually different relative positions. For example, measurement can be performed using the vision sensor while the vision sensor is moved to three or more positions.

At this time, the position information generating unit can generate the three-dimensional position information regarding the surface of the workpiece at each relative position. The face estimating unit can estimate the face information at each relative position. In addition, the correction amount setting unit can set the correction amount for driving the robot at at least one of the relative positions so that faces that are detected at the plurality of relative positions and include the surface of the workpiece match each other within a predetermined determination range.

For example, the correction amount setting unit may generate a reference face serving as a reference based on the three-dimensional position information acquired at one of the relative positions and correct other relative positions so that faces generated from the three-dimensional position information acquired at the other relative positions match the reference face.

When the above-described plate-shaped first workpiece 65 is used, the first face and the second face, which are planar, are calculated from the three-dimensional points set on the surface 65a. Then, the position of the vision sensor is corrected so that the first face and the second face match each other. Alternatively, the orientation of the vision sensor may be corrected so that the first face and the second face match each other. However, the relative position of the second face with respect to the first face in the directions in which the first face and the second face extend is not specified. In addition, the rotation angle around the normal direction of each of the first face and the second face is not specified.

For example, referring to FIG. 11, it is possible to correct the position of the workpiece 65 in the Z-axis direction of the robot coordinate system 71 and correct the orientation of the workpiece 65 around the W-axis and the P-axis. However, there remain positional errors in the X-axis direction and the Y-axis direction and an orientation error around the R-axis in the robot coordinate system 71. Thus, the positions and orientations of the vision sensor and the robot may be corrected by adopting a workpiece including a feature part having a characteristic shape at a surface thereof.

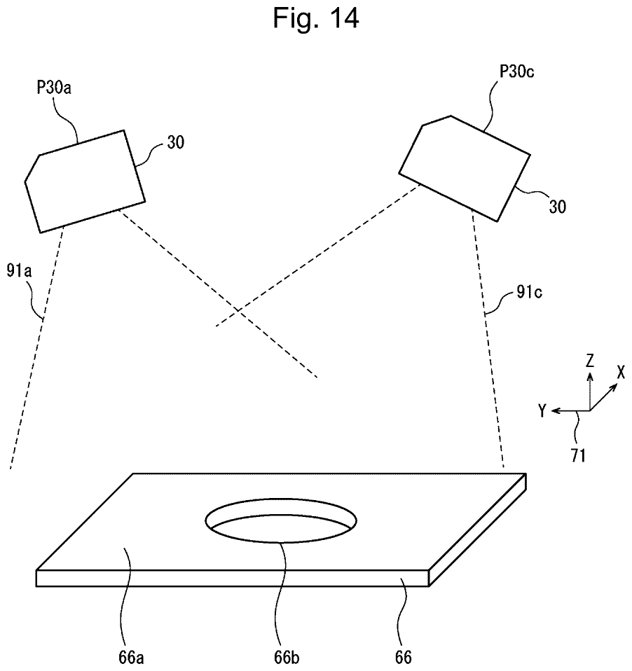

FIG. 14 illustrates a perspective view of a second workpiece and the vision sensor according to the present embodiment. A second workpiece 66 is formed into a plate shape. The workpiece 66 includes a hole 66b having a circular planar shape. Measurement is performed with the vision sensor 30 arranged at the first position P30a and the second position P30c, and thus the position and orientation of a surface 66a of the workpiece 66 are detected.

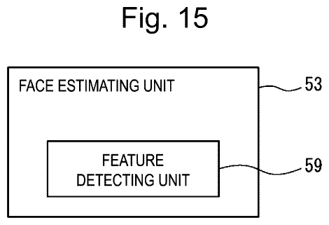

FIG. 15 is a block diagram of a modified example of the face estimating unit of the first robot device according to the present embodiment. Referring to FIG. 14 and FIG. 15, in the modified example of the first robot device, the face estimating unit 53 includes a feature detecting unit 59. The feature detecting unit 59 is formed so as to be able to detect the position of a feature part of the workpiece. For example, the feature detecting unit 59 is formed so as to perform pattern matching using three-dimensional position information. Alternatively, the feature detecting unit 59 is formed so as to perform pattern matching using a two-dimensional image.

When a correction amount for driving the robot 1 is set in teaching work, the feature detecting unit 59 detects the position of the hole 66b of the workpiece 66 in the measurement region 91a based on first three-dimensional position information acquired at the first position P30a. Further, the feature detecting unit 59 detects the position of the hole 66b of the workpiece 66 in a measurement region 91c based on second three-dimensional position information acquired at the second position P30c. The face estimating unit 53 estimates face information regarding a first face and face information regarding a second face.

The determination unit 54 compares the positions of the hole 66b in addition to comparison of the lengths and directions of normal vectors of the first face and the second face. The position and orientation of the robot at the second position can be changed until the difference between the position of the hole in the first three-dimensional position information and the position of the hole in the second three-dimensional position information falls within a determination range.

The correction amount setting unit 55 sets the correction amount so that the first face and the second face match each other within the determination range. Further, the correction amount setting unit 55 can set the correction amount so that the position of the hole 66b in the first three-dimensional position information acquired at the first position and the position of the hole 66b in the second three-dimensional position information acquired at the second position match each other within the determination range. By driving the robot based on this correction amount, it is possible to perform position matching of three-dimensional points in the direction parallel to each of the directions in which the first face and the second face extend. In addition to the W-axis direction, the P-axis direction, and the Z-axis direction of the robot coordinate system 71, the positions of the three-dimensional points in the X-axis direction and the Y-axis direction can be matched. The correction amount of the position and orientation of the robot can be set so that the positions of the hole 66b of the second workpiece 66 match each other.

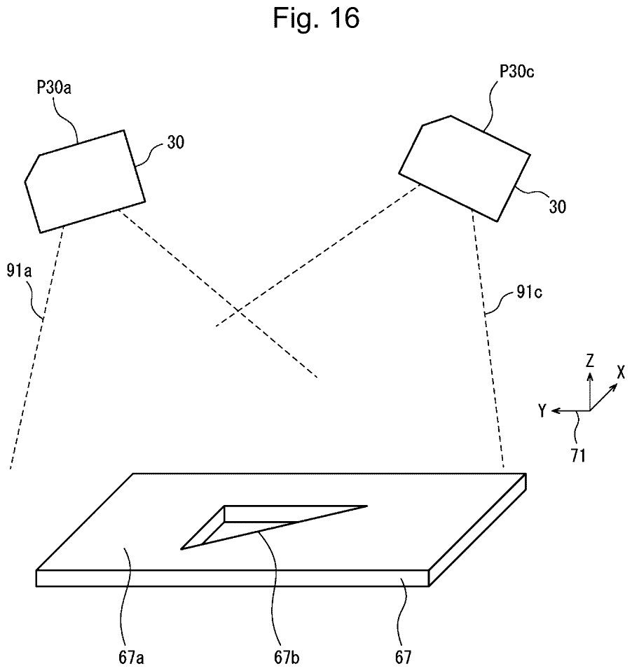

FIG. 16 is a perspective view of a third workpiece and the vision sensor according to the present embodiment. The hole 66b, which is a feature part of the second workpiece 66, has a circular planar shape. The hole 66b has a planar shape that is point symmetric. On the other hand, a feature part having an asymmetrical planar shape is formed in a third workpiece 67. The third workpiece 67 is formed into a plate shape. A hole 67b having a triangle planar shape is formed in the third workpiece 67. The feature detecting unit 59 can detect the position of the hole 67b in the measurement region.

The determination unit 54 compares the position of the hole 67b in first three-dimensional position information with the position of the hole 67b in second three-dimensional position information. Then, the position and orientation of the robot at the second position can be changed until the difference between the positions of the hole portion 67b falls within a determination range. The correction amount setting unit 55 can set a correction amount so that the position of the hole 67b in the three-dimensional position information acquired at the first position and the position of the hole 67b in the three-dimensional position information acquired at the second position match each other.

In the third workpiece 67, the feature part having an asymmetric planar shape is formed. Thus, position matching around each of normal directions of a first face and a second face can be performed. Referring to FIG. 16, in addition to the W-axis direction, the P-axis direction, and the Z-axis direction of the robot coordinate system 71, the positions of three-dimensional points in the X-axis direction, the Y-axis direction, and the R-axis direction can be matched. It is possible to set the correction amount of the position and orientation of the robot 1 so that the positions and orientations of the hole 67b of the third workpiece 67 match each other.

For the third workpiece, an example in which the planar shape of the feature part is neither point symmetrical nor line symmetrical is described. As the asymmetric feature part, feature parts may be formed at a plurality of asymmetric positions of the workpiece. For example, a feature part such as a protruding part may be formed at a part corresponding to each apex of the triangle of the hole of the third workpiece.

Although a case in which the surface of the workpiece is planar is described in the above-described embodiment, the embodiment is not limited to this. The control according to the present embodiment can be applied to a case in which the surface of the workpiece is curved.

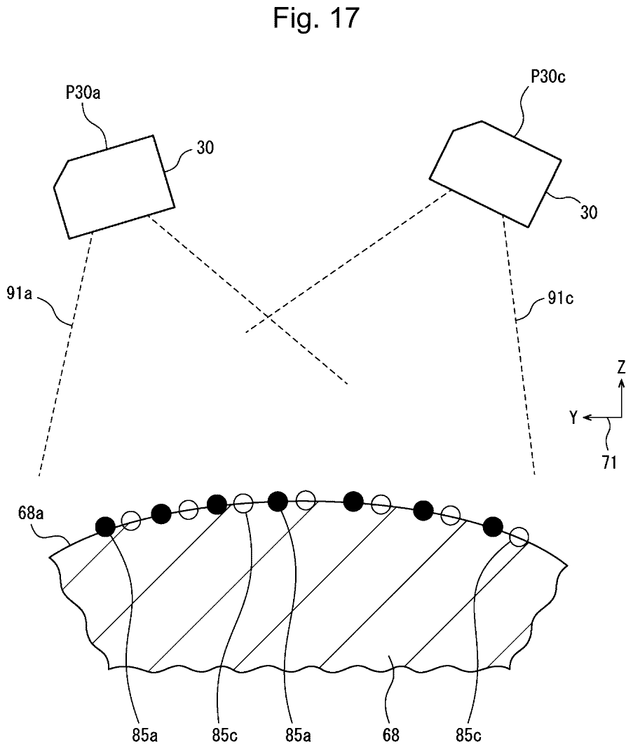

FIG. 17 is a schematic view of a fourth workpiece and the vision sensor according to the present embodiment. A surface 68a of a fourth workpiece 68 is formed into a curved shape. First three-dimensional points 85a set based on an output of the vision sensor 30 arranged at the first position P30a and second three-dimensional points 85c set based on an output of the vision sensor 30 arranged at the second position P30c are set.

Even in the case of such a curved face, the correction amount setting unit 55 can set, through face matching control in teaching work similar to the above, a correction amount for driving the robot 1 at the second position P30c so that a first face that is detected at the first position P30a and that includes a surface of the workpiece 68 and a second face that is detected at the second position P30c and that includes a surface of the workpiece 68 match each other within a predetermined determination range. In actual work of the robot device, the position and orientation of the robot are corrected based on the correction amount, and three-dimensional position information can be detected.

Alternatively, when the surface of the workpiece is curved, a reference face serving as a reference of the surface 68a of the workpiece 68 can be set in advance in a three-dimensional space. The shape of the surface 68a can be generated based on three-dimensional shape data output from a computer aided design (CAD) device. Regarding the position of the surface 68a of the workpiece 68 in the robot coordinate system 71, the workpiece 68 is first arranged at the platform. Next, a touch-up pen is attached to the robot 1, and the touch-up pen is brought into contact with contact points set at a plurality of positions of the surface 68a of the workpiece 68. The plurality of positions of the contact points are detected in the robot coordinate system 71. Based on the plurality of positions of the contact points, the position of the workpiece 68 in the robot coordinate system 71 can be determined and the reference face in the robot coordinate system 71 can be generated. The storage part stores the generated reference face of the workpiece 68.

The processing unit can adjust the first position and the second position of the vision sensor 30 so that the shape and the position of the reference face of the workpiece 68 are matched. The correction amount setting unit 55 can calculate the position and orientation of the robot so that the first face matches the reference face. In addition, the correction amount setting unit 55 can calculate the position and orientation of the robot 1 so that the second face matches the reference face. Then, the correction amount setting unit 55 can calculate the correction amount for driving the robot 1 at each position.

When the reference face corresponding to the surface of the workpiece is generated in advance based on an output of the CAD device or the like, it is preferable that the measurement region for the first position and the measurement region for the second position substantially overlap each other. This is suitable for control of interpolating missing three-dimensional points due to halation.

In the above-described embodiment, the position and orientation of the vision sensor are changed by the robot while the position and orientation of the workpiece are fixed. However, the embodiment is not limited to this. The robot device can adopt any mode of changing the relative position between the workpiece and the vision sensor.

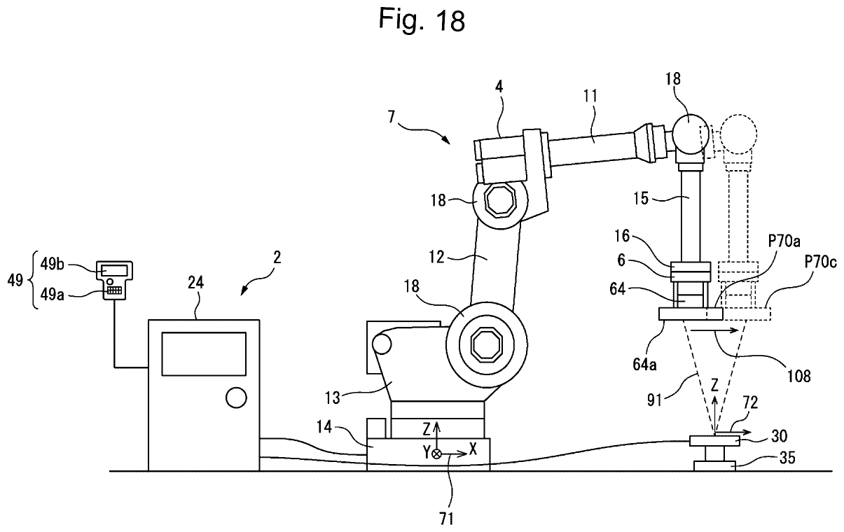

FIG. 18 is a side view of a second robot device according to the present embodiment. In a second robot device 7, the position and orientation of a vision sensor 30 are fixed, and a robot 4 changes the position and orientation of a workpiece 64. The second robot device 7 includes the robot 4 and a hand 6 as a work tool attached to the robot 4. In a manner similar to the robot 1 of the first robot device 3, the robot 4 is a six-axis vertical articulated robot. The hand 6 includes two finger parts that face each other. The hand 6 is formed so as to grasp the workpiece 64 by sandwiching the workpiece 64 with the finger parts.

The second robot device 7 includes a controller 2 that controls the robot 4 and the hand 6 in a manner similar to the first robot device 3. The second robot device 7 includes the vision sensor 30 as a three-dimensional sensor. The position and orientation of the vision sensor 30 are fixed by a platform 35 as a fixing member.

In the second robot device 7 according to the present embodiment, surface inspection of a surface 64a of the workpiece 64 is performed. For example, based on synthesized three-dimensional position information of the workpiece 64, a processing unit can perform inspection of the shape of the contour of the surface of the workpiece 64, inspection of the shape of a feature part formed at the surface of the workpiece 64, and the like. The processing unit can determine whether or not each variable is within a predetermined determination range.

The second robot device 7 generates three-dimensional position information regarding the surface 64a of the workpiece 64 based on an output of the vision sensor 30. The area of the surface 64a of the workpiece 64 is larger than that of a measurement region 91 of the vision sensor 30. For this reason, the robot device 7 arranges the workpiece 64 at a first position P70a and generates first three-dimensional position information. The robot device 7 also arranges the workpiece 64 at a second position P70c and generates second three-dimensional position information. In this manner, the robot 4 changes the relative position between the workpiece 64 and the vision sensor 30 from a first relative position to a second relative position by moving the workpiece 64 from the first position P70a to the second position P70c. In this example, the robot 4 moves the workpiece 64 in the horizontal direction as indicated by an arrow 108. At the second position P70c, the second position P70c may be displaced from a desired position due to a driving error of a driving mechanism of the robot.

A position information generating unit 52 of the second robot device generates the first three-dimensional position information based on an output of the vision sensor 30 that has imaged the surface 64a of the workpiece 64 arranged at the first position P70a. The position information generating unit 52 also generates the second three-dimensional position information based on an output of the vision sensor 30 that has imaged the surface 64a of the workpiece 64 arranged at the second position P70c.

A face estimating unit 53 generates face information related to a first face and face information related to a second face including the surface 64a based on the respective pieces of three-dimensional position information. A correction amount setting unit 55 can set a correction amount for driving the robot 4 at the second position P70c so that the first face estimated from the first three-dimensional position information and the second face estimated from the second three-dimensional position information match each other within a predetermined determination range. In actual inspection work, the position and orientation of the robot at the second position can be corrected based on the correction amount set by the correction amount setting unit 55.

In the second robot device 7 as well, it is possible to suppress an error of the three-dimensional position information caused by a driving error of the robot 4. By driving the robot 4 based on the correction amount for driving the robot 4 at the second position, the robot device 7 can perform accurate inspection.

Other configurations, operation, and effect of the second robot device are similar to those of the first robot device, and thus description thereof will not be repeated here.

The three-dimensional sensor according to the present embodiment is a vision sensor including the two two-dimensional cameras. However, the embodiment is not limited to this. Furthermore, any sensor that can generate the three-dimensional position information regarding the surface of the workpiece can be employed as the three-dimensional sensor. For example, a time of flight (TOF) camera that acquires three-dimensional position information based a flight time of light can be employed as the three-dimensional sensor. Further, a stereo camera as the vision sensor according to the present embodiment includes a projector, but the embodiment is not limited to this. The stereo camera does not need to include a projector.

In the present embodiment, the controller that controls the robot functions as the processing unit that processes the output of the three-dimensional sensor, but the embodiment is not limited to this. The processing unit may be configured by an arithmetic processing device (a computer) different from the controller that controls the robot. For example, a tablet terminal functioning as the processing unit may be connected to the controller that controls the robot.

The robot device according to the present embodiment performs work of conveying the workpiece or inspecting the workpiece, but the embodiment is not limited to this. The robot device can perform any work. Moreover, the robot according to the present embodiment is a vertical articulated robot, but the embodiment is not limited to this. Any robot moving the workpiece can be employed. For example, a horizontal articulated robot can be employed.

The above embodiments may be combined as appropriate. In each of the above controls, the sequence of steps can be changed as appropriate to the extent that the functionality and action are not changed.

In the above respective drawings, the same or equivalent portions are denoted by the same reference signs. It should be noted that the above embodiments are examples and do not limit the invention. The embodiments also include modifications of the embodiments illustrated in the claims.

1. A robot device comprising:
a three-dimensional sensor configured to detect a position of a surface of a workpiece;
a robot configured to change a relative position between the workpiece and the three-dimensional sensor;
a position information generating unit configured to generate three-dimensional position information regarding the surface of the workpiece based on an output of the three-dimensional sensor;
a face estimating unit configured to estimate face information related to a face including the surface of the workpiece based on the three-dimensional position information; and
a correction amount setting unit configured to set a correction amount for driving the robot, wherein
the robot is configured to change the relative position between the workpiece and the three-dimensional sensor from a first relative position to a second relative position different from the first relative position, and
the correction amount setting unit is configured to set the correction amount for driving the robot at the second relative position based on the face information so that a first face and a second face match each other, the first face being detected at the first relative position and including the surface of the workpiece, the second face being detected at the second relative position and including the surface of the workpiece.

2. The robot device of claim 1, wherein the robot is configured to change a relative orientation between the workpiece and the three-dimensional sensor from a first relative orientation to a second relative orientation.

3. The robot device of claim 1, wherein
the three-dimensional sensor is attached to the robot,
the workpiece is arranged such that a position and orientation of the workpiece are fixed, and
the robot is configured to change the relative position between the workpiece and the three-dimensional sensor from the first relative position to the second relative position by moving the three-dimensional sensor from a first position to a second position.

4. The robot device of claim 1, comprising a work tool attached to the robot and configured to grasp the workpiece, wherein
a position and orientation of the three-dimensional sensor are fixed by a fixing member, and
the robot is configured to change the relative position between the workpiece and the three-dimensional sensor from the first relative position to the second relative position by moving the workpiece from a first position to a second position.

5. The robot device of claim l, wherein
the robot is configured to change the relative position between the workpiece and the three-dimensional sensor to three or more mutually different relative positions,
the position information generating unit is configured to generate the three-dimensional position information regarding the surface of the workpiece at each of the relative positions,
the face estimating unit is configured to estimate the face information at each of the relative positions, and
the correction amount setting unit is configured to set the correction amount for driving the robot at at least one of the relative positions so that faces that are detected at a plurality of relative positions and include the surface of the workpiece match each other within a predetermined determination range.

6. The robot device of claim 1, comprising a synthesis unit configured to synthesize a plurality of pieces of the three-dimensional position information regarding the surface of the workpiece acquired at a plurality of relative positions, wherein
the synthesis unit is configured to synthesize the three-dimensional position information generated at the first relative position and the three-dimensional position information generated at the second relative position corrected based on the correction amount set by the correction amount setting unit.

7. A control method of a robot device, the control method comprising:
arranging, by a robot, a relative position between a workpiece and a three-dimensional sensor at a first relative position;
generating, by a position information generating unit, three-dimensional position information regarding a surface of the workpiece at the first relative position based on an output of the three-dimensional sensor;
arranging, by the robot, the relative position between the workpiece and the three-dimensional sensor at a second relative position different from the first relative position;
creating, by the position information generating unit, three-dimensional position information regarding the surface of the workpiece at the second relative position based on an output of the three-dimensional sensor;
estimating, by a face estimating unit, face information related to a face including the surface of the workpiece based on the three-dimensional position information at each of the relative positions; and
setting, by a correction amount setting unit, a correction amount for driving the robot at the second relative position based on the face information so that a first face and a second face match each other, the first face being detected at the first relative position and including the surface of the workpiece, the second face being detected at the second relative position and including the surface of the workpiece.
